(19) United States
(12) Patent Application Publication
(10) Pub. No.: US 2005/0212394 A1
(43) Pub. Date: Sep. 29, 2005

(54) Carbon nanotube substrate structure

(76) Inventors: Jing-Shie Lin, Dali City (TW); Yi-Lung Chiang, Daya Township (TW); Chin-Tien Hsiao, Taichung City (TW); Chia-Chih Chuang, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/091,495

(22) Filed: Mar. 29, 2005

(30) Foreign Application Priority Data
Mar. 29, 2004 (JP) 2004-096907

(51) Int. Cl. H01J 1/02

(52) U.S. Cl. 313/309; 313/495

(57) ABSTRACT

A carbon nanotube substrate structure including a substrate and a conductive layer disposed thereon. The carbon nanotube layer or the conductive layer has numerous support particles with a diameter smaller than the length of the carbon nanotube of the carbon nanotube layer. The carbon nanotubes, the conductive layer and the support particles are adhered to each other by means of a glue. The carbon nanotubes lean on the support particles, whereby the carbon nanotubes can stand and protrude from the surface of the carbon nanotube layer to serve as field emission sources.

### BACKGROUND OF THE INVENTION

The present invention is related to a carbon nanotube substrate structure in which the carbon nanotubes are supported by numerous support particles, whereby the carbon nanotubes can stand and protrude from the surface of the carbon nanotube layer to serve as field emission sources. By means of the above arrangement, the effect of the field emission and the evenness of the length of the carbon nanotubes are enhanced.

In a conventional cathode ray tube (CRT), an electronic gun emits electron beam. A deflector controls the direction of the electron beam to collide a luminescent panel so as to present a picture. Such conventional CRT has large volume and heavy weight.

Field emission display has been developed recently FIG. 6 shows the basic structure of a field emission display. The field emission display includes an anode board (luminescent board) 81, a cathode board 82 and a vacuum sealed region 83 defined between the anode board and cathode board. Several thousands of thousand micro-tips are arranged on the cathode board 82 as emission sources 84. Control gates 85 are arranged around the emission sources 84 for controlling the current emitted from the emission sources 84.

The field emission display has numerous emission sources 84, whereby each pixel is produced by one single emission source 84 which emits electron to collide the anode board 81 and emit light. Therefore, the thickness of the display can be greatly reduced to be less than several centimeters.

However, due to the limitation of the vapor-deposition technique for forming the micro-tips, the ratio of good products of the display is considerably reduced. Moreover, the tips of the emission sources tend to wear so that the using life is shortened. Therefore, it is still hard to commercialize the field emission display.

Recently, carbon nanotube has been developed. The carbon nanotube is usable as the emission source. Such display is the so-called carbon nanotube-field emission display (CNT-FED). In the current lab stage of CNT-FED, by means of chemical vapor-growth, the carbon nanotube is grown on the cathode board. Currently, such measure can be hardly applied to mass-production. Moreover, the difficulties caused by the high temperature necessary for the growth and the evenness of the vapor-deposition can be hardly overcome. Accordingly, some manufacturers manufacture the CNT-FED with a measure as follows:

A conductive layer 92 is laid on the cathode board 91. A carbon nanotube 93 is coated on the conductive layer 92. Before coated, the carbon nanotube 93 is first blended with a glue 94. After the glue is solidified, an dielectric layer 95 and a gate layer 96 are laid on the carbon nanotube 93. Then the dielectric layer 95 is etched according to the array of the display to expose the carbon nanotube 93 as shown in FIG. 7. Accordingly, the carbon nanotube 93 can serve as an emission source to discharge in a low-voltage condition.

The carbon nanotube 93 is first blended with the glue 94 and then coated on the conductive layer 92. Therefore, the carbon nanotubes 93 mostly will intersect and overlap each other in an inclined state. In addition, most of the carbon nanotubes 93 are enclosed by the glue 94 and adhered to the surface of the conductive layer 92. Therefore, only a very short part of the carbon nanotube 93 is exposed. Moreover, the glue 94 is generally an insulating glass glue with low melting point. Therefore, a part of the carbon nanotube 93 enclosed in the glue 94 will be unable to directly contact with the conductive layer 92. This part will become void field emission source. Therefore, the emission effect will be affected. Furthermore, it is hard to accurately control the length of the protruding carbon nanotube 93 so that the evenness of field emission is poor. The evenness of the conventional field emission display can hardly exceed 50%. All the above problems should be solved.

### SUMMARY OF THE INVENTION

It is therefore a primary object of the present invention to provide a carbon nanotube substrate structure in which numerous support particles are contained in the carbon nanotube layer or the conductive layer. The support particles have a diameter smaller than the length of the carbon nanotube of the carbon nanotube layer. The carbon nanotubes can lean on the support particles, whereby the carbon nanotubes can stand and protrude from the surface of the carbon nanotube layer to serve as effective field emission sources. By means of the above arrangement, the effect of the field emission is enhanced.

It is a further object of the present invention to provide the above carbon nanotube substrate structure in which the carbon nanotube layer contains numerous conductive particles for enhancing electrical connection between the carbon nanotubes and the conductive layer.

According to the above objects, the carbon nanotube substrate structure of the present invention includes a substrate and a conductive layer disposed thereon. The carbon nanotube layer has numerous carbon nanotubes and support particles with a diameter smaller than the length of the carbon nanotube. The carbon nanotubes, the conductive layer and the support particles are adhered to each other by means of a glue. The carbon nanotubes lean on the support particles, whereby the carbon nanotubes can stand and protrude from the surface of the carbon nanotube layer to serve as effective field emission sources.

The present invention can be best understood through the following description and accompanying drawings wherein:

### BRIEF DESCRIPTION OF THE DRAWINGS

FIG. 1 is a sectional view of the carbon nanotube substrate structure of the present invention;

FIG. 2 is a block manufacturing flow chart of the carbon nanotube substrate structure of the present invention;

FIG. 3 is a manufacturing flow chart of the carbon nanotube substrate structure of the present invention;

FIG. 4 is a sectional view of a second embodiment of the carbon nanotube substrate structure of the present invention;

FIG. 5 is a sectional view showing the manufacturing flow chart of a third embodiment of the carbon nanotube substrate structure of the present invention;

FIG. 6 is a sectional view of a conventional field emission display; and

FIG. 7 is a sectional view of a conventional carbon nanotube-field emission display.

### DETAILED DESCRIPTION OF THE PREFERRED EMBODIMENTS

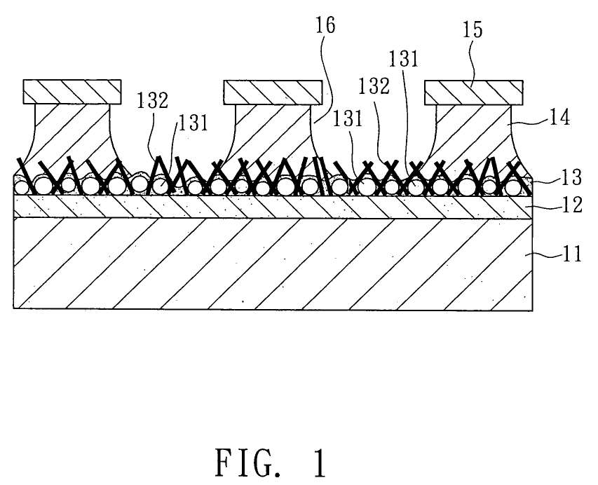

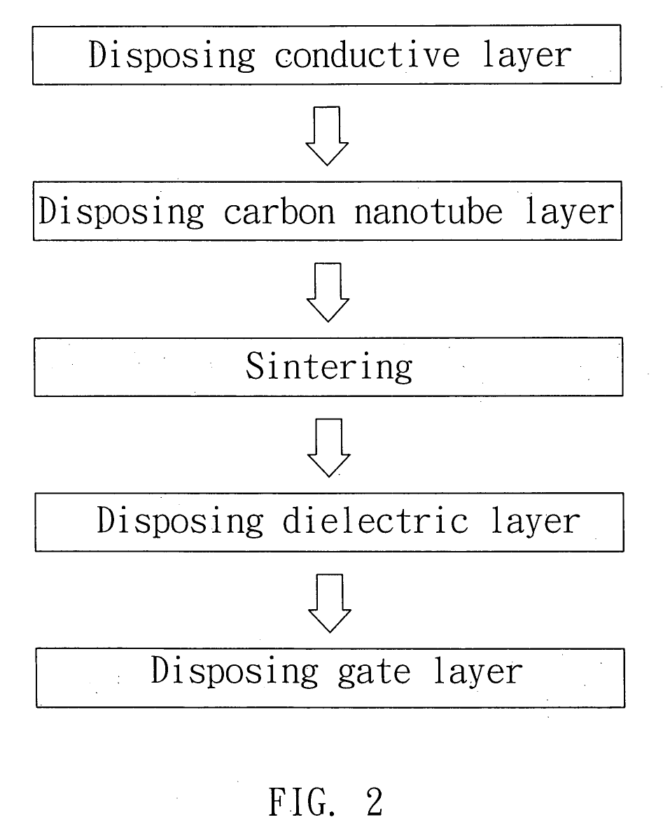

Please refer to FIGS. 1 to 3. The carbon nanotube substrate structure of the present invention includes a substrate 11 and a conductive layer 12 disposed thereon. A carbon nanotube layer 13 is disposed on the conductive layer 12. The carbon nanotube layer 13 has numerous straight carbon nanotubes 132 and support particles 131 with a diameter smaller than the length of the carbon nanotube 132. The carbon nanotubes 132, the conductive layer 12 and the support particles 131 are adhered to each other by means of a glue. The carbon nanotubes 132 lean on the support particles 131, whereby the carbon nanotubes 132 can stand to protrude from the surface of the carbon nanotube layer 13. A dielectric layer 14 and a gate layer 15 which overlap each other are sequentially laid on the carbon nanotube layer 13. The dielectric layer 14 and the gate layer 15 are formed with a hole 16 corresponding to each position of the display array. The carbon nanotube 132 in the hole 16 can be exposed to serve as the field emission source of the cathode board of the field emission display.

The method for manufacturing the carbon nanotube substrate structure includes steps of:
a. disposing a conductive layer 12 on a substrate 11, the conductive layer 12 being made of silver and glass material;
b. disposing a carbon nanotube layer 13 on the conductive layer 12, in this embodiment, the carbon nanotube layer 13 being composed of numerous support particles 131, numerous straight carbon nanotubes 132 and a glue, in this embodiment, the glue being a glass glue with low melting point, the support particles 131, carbon nanotubes 132 and the glue being mixed and blended and then coated on the conductive layer 12 to form the carbon nanotube layer 13, the support particles 131 having a diameter smaller than the length of the carbon nanotube 132, the carbon nanotubes 132, the conductive layer 12 and the support particles 131 being adhered to each other by means of the glue, the carbon nanotubes 132 leaning on the support particles 131, whereby the carbon nanotubes 132 can stand to protrude from the surface of the carbon nanotube layer 13;
c. sintering the substrate 11 to firmly bind the carbon nanotubes 132, the support particles 131 and the conductive layer 12 with each other;
d. disposing a dielectric layer 14 on the carbon nanotube layer 13; and
e. disposing a gate layer 15 on the dielectric layer 14, the dielectric layer 14 and the gate layer 15 being etched with multiple holes 16 according to the positions of the display array, whereby the carbon nanotubes 132 in the holes 16 can be exposed to serve as the field emission sources.

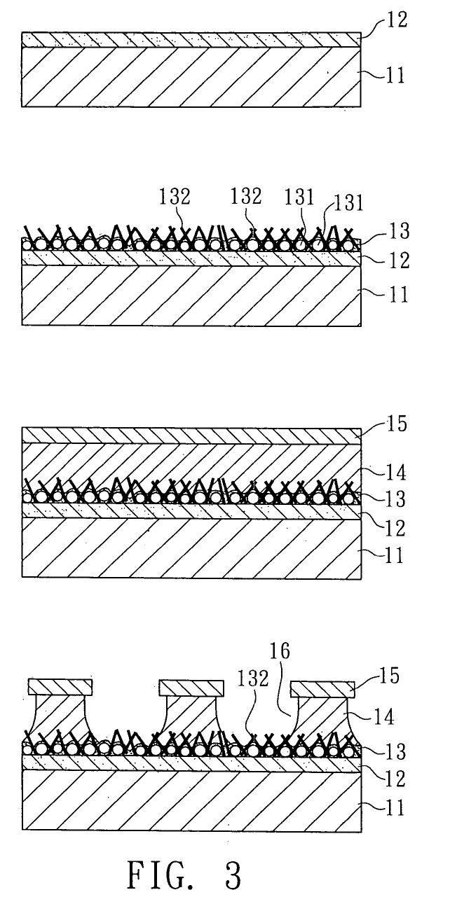

The carbon nanotube layer 13 of the present invention has numerous straight carbon nanotubes 132 and support particles 131 with a diameter smaller than the length of the carbon nanotube 132. The carbon nanotubes 132 and the support particles 131 are blended with the glue and coated on the conductive layer 12. The carbon nanotubes 132 lean on the support particles 131, whereby the carbon nanotubes 132 can stand to protrude from the surface of the carbon nanotube layer 13 as shown in FIG. 3. The carbon nanotube itself has a high strength and is not easy to bend due to its own weight. When leaning on the support particle, one end of the carbon nanotube is rested on the conductive layer due to gravity, while the othe rend of the carbon nanotube is directed to one side away from the conductive layer due to the support of the support particle. The support particle is made of ceramic/porcelain or carbon ball with high melting point. Therefore, when sintering the glue, the support particles will not be adhered to and bonded with the carbon nanotubes due to the high temperature. By means of such design, it is ensured that when an electric field is applied to the carbon nanotube substrate, the carbon nanotubes are arranged in accordance with the direction of the electric field. Therefore, the characteristics of the field emission are enhanced and the carbon nanotubes will be more flush with each other at the same height. That is, the protruding carbon nanotubes can apparently form the micro-tips to serve as effective field emission sources.

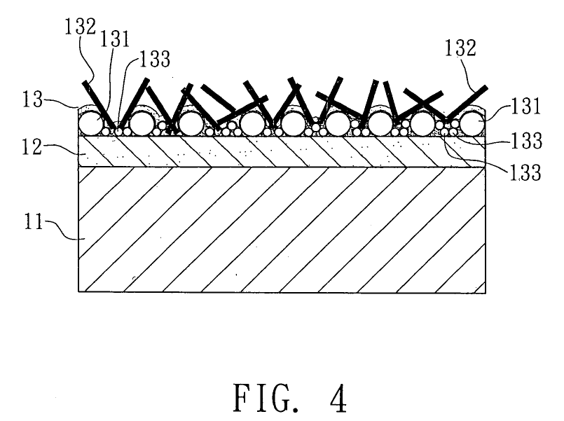

The above embodiment can be variously modified. For example, in step b of disposing the carbon nanotube layer, numerous support particles 131, numerous conductive particles 133 and little amount of glue are first blended and then coated on the conductive layer 12 to form concavo-convex surface on the conductive layer 12. Then the carbon nanotubes 132 are blended with the glue and coated on the concavo-convex surface as shown in FIG. 4 to form the carbon nanotube layer 13. Similarly, the carbon nanotubes 132 can lean on the support particles 131, whereby the carbon nanotubes 132 can stand to protrude from the surface of the carbon nanotube layer 13. The conductive particles 133 serve to electrically connect the carbon nanotubes 132 with the conductive layer 12. This can achieve the same effect as the first embodiment.

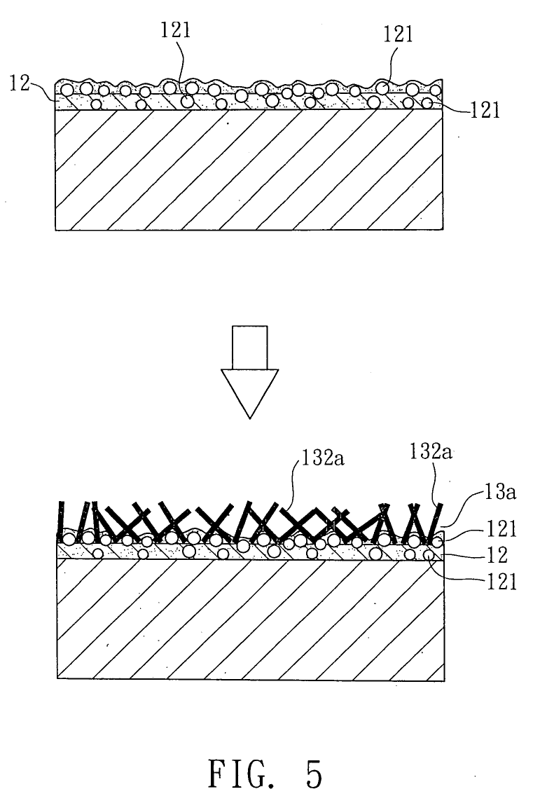

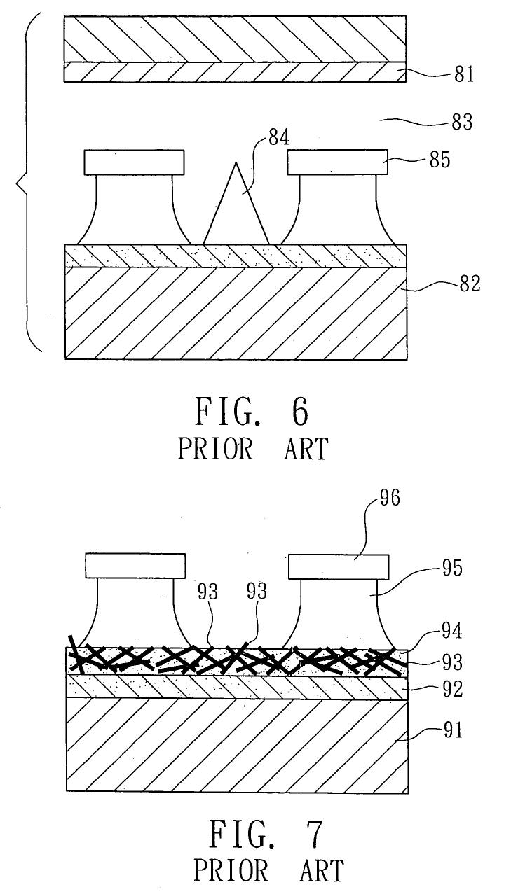

In step a of disposing the conductive layer, the support particles 121 can be blended with the conductive layer 12a to form concavo-convex surface on the conductive layer 12a as shown in FIG. 5. Then, in step b of disposing the carbon nanotube layer, numerous straight carbon nanotubes 132 are blended with the glue and coated on the conductive layer 12a. (An organic adhesive can be added into the carbon nanotubes and halftone printed on the surface.) Accordingly, the carbon nanotubes 132 are supported by the concavo-convex surface formed of the support particles 121 to stand and protrude from the surface of the carbon nanotube layer 13a. Then the carbon nanotube layer 13a is sintered. Accordingly, the ineffective field emission sources are reduced. In addition, most of the carbon nanotubes are arranged on the surface so that the unevenness of the length of the embedded carbon nanotubes is minified. This can achieve the same effect as the first embodiment.

The above embodiments are only used to illustrate the present invention, not intended to limit the scope thereof. Many modifications of the above embodiments can be made without departing from the spirit of the present invention.

1. A carbon nanotube substrate structure comprising a substrate and a conductive layer disposed thereon, the carbon nanotube layer having numerous carbon nanotubes and support particles with a diameter smaller than the length of the carbon nanotube, the carbon nanotubes, the conductive layer and the support particles being adhered to each other by means of a glue, the carbon nanotubes leaning on the support particles, whereby the carbon nanotubes can stand to protrude from the surface of the carbon nanotube layer.

2. The carbon nanotube substrate structure as claimed in claim 1, wherein a dielectric layer and a gate layer which overlap each other are sequentially laid on the carbon nanotube layer, the dielectric layer and the gate layer being formed with a hole corresponding to each position of a display array, whereby the carbon nanotube in the hole can be exposed to serve as the field emission source.

3. The carbon nanotube substrate structure as claimed in claim 1, wherein the carbon nanotube layer includes numerous conductive particles for electrically connecting the carbon nanotubes with the conductive layer.

4. A carbon nanotube substrate structure comprising a substrate and a conductive layer disposed thereon, the conductive layer containing numerous support particles to form concavo-convex surface on the conductive layer, a carbon nanotube layer being disposed on the conductive layer, the carbon nanotube layer having numerous carbon nanotubes with a length larger than the diameter of the support particles, the carbon nanotubes being adhered to the conductive layer by a glue, whereby the carbon nanotubes lean on the support particles to stand and protrude from the surface of the carbon nanotube layer.

5. The carbon nanotube substrate structure as claimed in claim 4, wherein a dielectric layer and a gate layer which overlap each other are sequentially laid on the carbon nanotube layer, the dielectric layer and the gate layer being formed with a hole corresponding to each position of a display array, whereby the carbon nanotube in the hole can be exposed to serve as the field emission source.
